(19) United States
(12) Patent Application Publication
(10) Pub. No.: US 2004/0044104 A1
(43) Pub. Date: Mar. 4, 2004

(54) Elastic pavement material containing waste rubber

(76) Inventors: Mitsuaki Maeda, Tokyo (JP); Ryuji Izumoto, Tokyo (JP); Hideshi Yanagi, Kanagawa (JP); Satoru Kawamata, Tokyo (JP)

Correspondence Address: SUGHRUE MION, PLLC, 2100 PENNSYLVANIA AVENUE, N.W., WASHINGTON, DC, 20037, US

(21) Appl. No.: 10/450,682

(22) PCT Filed: Dec. 26, 2001
(86) PCT No.: PCT/JP01/11466

(30) Foreign Application Priority Data
Dec. 28, 2000 (JP) 2000-402179

(51) Int. Cl. C08J 3/00

(52) U.S. Cl. 524/59

(57) ABSTRACT

A low-cost, low-noise pavement is realized by a waste-rubber-containing elastic pavement material which includes waste rubber resulting from waste spent-tires and the like, a binder and an aggregate while a pavement after application has a coefficient of restitution to a golf ball of 20 to 60. An urethane-based or epoxy-based curable resin is suitable for use as the binder. Preferably, the contents of the waste rubber and the binder are 30% to 70% by volume and 10% to 30% by volume respectively.

### TECHNICAL FIELD

The present invention relates to an elastic pavement material using waste rubber. In particular, the present invention relates to a waste-rubber-containing elastic pavement material (hereafter may be briefly referred to as “a pavement material”) capable of realizing a pavement having an excellent low-noise property.

### BACKGROUND ART

In recent years, a drainage pavement has sprung into wide use in place of a conventional dense-graded pavement. In the drainage pavement, cavities are provided in the pavement in order to reduce the traffic noise. According to this drainage pavement, the noise can be reduced by about 3 dB than ever. However, in many areas, the noise cannot be sufficiently reduced by this drainage pavement, and therefore, a technology for further reducing the noise has been required.

On the other hand, a method, in which waste rubber is integrated, and then, is used as a molding, is a known recycling technology for effective reclamation of waste vulcanized rubber resulting from waste tires and the like. In addition, various proposals were made regarding the pavement capable of realizing an excellent low-noise property while effective use of the waste rubber was achieved. Examples of proposals include, for example, (1) an elastic pavement in which waste vulcanized rubber was added using an urethane binder rather than a conventional asphalt binder (described in Japanese Patent No. 2869459, Japanese Patent No. 2869458 and the like) and (2) an asphalt pavement containing waste vulcanized rubber, in which the waste vulcanized rubber was made into the shape of a powder or chips, followed by addition to the asphalt binder pavement (described in Japanese Unexamined Patent Application Publication No. 9-165248 and Japanese Unexamined Patent Application Publication No. 6-279684).

However, it cannot be said that sufficient effect of reducing the noise has been achieved with respect to the above-mentioned conventionally proposed elastic pavements. Consequently, a technology for realizing a pavement capable of achieving excellent reduction in the noise is required.

Accordingly, it is an object of the present invention to provide a waste-rubber-containing elastic pavement material, which can achieve unprecedentedly excellent reduction in the noise and which can also achieve reduction in the cost by using recycled waste rubber.

### DISCLOSURE OF INVENTION

In order to overcome the above-mentioned problems, the inventors of the present invention focused attention on the physical characteristics of elastic pavements, and earnestly performed research. As a result, it was found out that excellent reduction in the noise can be achieved by specifying the value of a specific physical property related to a capability of reducing the noise to be within a predetermined range, and therefore, the present invention was made.

A waste-rubber-containing elastic pavement material of the present invention includes waste rubber, a binder and an aggregate, wherein a pavement after application has a coefficient of restitution to a golf ball of 20 to 60.

In the present invention, preferably, the above-mentioned binder is an urethane-based or epoxy-based curable resin. Preferably, the content of the above-mentioned waste rubber is 30% to 70% by volume. Preferably, the content of the above-mentioned binder is 10% to 30% by volume. Furthermore, the waste-rubber-containing elastic pavement material of the present invention can be applied as a topcoat having a thickness of 5 to 30 mm onto a pavement. This is in particular preferable in the case where the above-mentioned pavement is a drainage pavement.

### BRIEF DESCRIPTION OF THE DRAWINGS

FIG. 1 is a schematic diagram showing a condition in which an elastic pavement according to the present invention is provided as a topcoat of a drainage pavement.

### BEST MODE FOR CARRYING OUT THE INVENTION

Embodiments of the present invention will be described below in detail.

A waste-rubber-containing elastic pavement material of the present invention includes waste rubber, a binder and an aggregate, wherein a pavement after application has a coefficient of restitution to a golf ball (hereafter may be briefly referred to as “a coefficient of restitution”) of 20 to 60, and preferably, is 30 to 50. In this manner, the pavement having a significant effect of reducing the noise can be achieved. The reason for this is believed that shock absorption performance of the pavement surface is one of the primary factors of reduction in the noise. The coefficient of restitution to a golf ball in the present invention is determined based on the height (cm) of bounce when a golf ball is dropped from a height of 100 cm above the pavement surface.

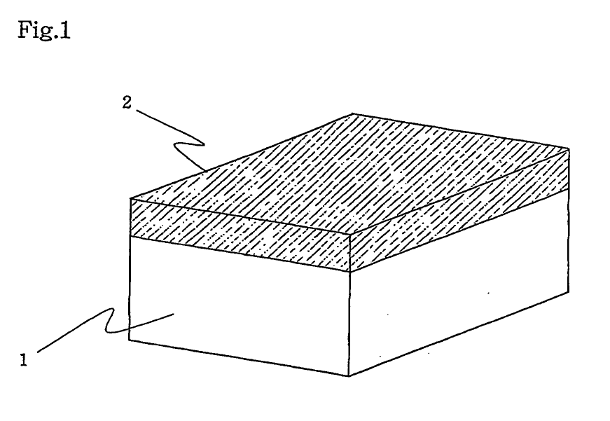

In the present invention, it is important that the coefficient of restitution of the pavement surface is specified to be within a predetermined range. Consequently, the pavement may not be formed from the pavement material according to the present invention along its entire thickness, and as shown in FIG. 1, application as a topcoat 2 can be performed onto a pavement constructed from other pavement material, in particular, a drainage pavement 1. In this case, the thickness of the topcoat 2 according to the present invention is specified to be 5 to 30 mm, and preferably, be 10 to 20 mm. That is, when the pavement material of the present invention is used alone, a newly-formed pavement must have a thickness of 30 to 50 mm in a manner similar to that in a conventional pavement. However, in the case where application is performed as a topcoat onto a conventional drainage pavement, an effect of the present invention on reduction in the noise can be sufficiently achieved even when the thickness of a newly-formed portion is small. The drainage pavement is preferable as a base pavement because there is a strong correlation between the amount of water penetration and the sound absorption coefficient. These values are under the domination of the porosity in the pavement.

In the pavement material of the present invention, it is essential that the coefficient of restitution to a golf ball falls within the above-mentioned range, and constituent materials are not specifically limited.

Materials for the waste rubber are not specifically limited, and natural rubber, isoprene rubber, styrene-butadiene rubber, butyl rubber, ethylene-propylene rubber and the like can be used. The above-mentioned waste vulcanized rubber can be produced from waste spent-materials, e.g. rubber tires, weather strips and hoses, unnecessary scraps generated during molding, defective moldings and the like. The size of the rubber for use is 1 to 10 mm, and preferably, is 2 to 8 mm. When the size of the vulcanized rubber is less than 1 mm, elasticity sufficient for a pavement cannot be achieved, and the effect of reducing the noise is insufficient. On the other hand, when exceeding 10 mm, since it is too large, flying of the rubber is increased during practical use. This is undesirable from the viewpoint of durability.

The binder is not specifically limited, and examples thereof include, for example, asphalt, asphalt emulsion, one-component urethane, two-component urethane and epoxy. However, an urethane-based or epoxy-based curable resin is suited for the binder.

In the present invention, preferably, the content of the waste rubber in the total pavement materials is 30% to 70% by volume, and more preferably, is 40% to 60% by volume. Preferably, the content of the binder is 10% to 30% by volume, and more preferably, is 15% to 25% by volume. Preferably, the waste rubber and the binder are within the above-mentioned respective ranges in order to achieve the coefficient of restitution within the above-mentioned range and to achieve the desired effects of the present invention.

The aggregate is not specifically limited, and natural aggregates, e.g. river gravel and river sand, crushed stones, slugs, concrete, glass, FRPs and the like can be used. Stone, sand and the like used for this aggregate serves to ensure the strength and the abrasion resistance of a completed pavement and to achieve a slip-resistance function through exposure at the surface. Preferably, the stone has a function of decentralizing a load by mutual engagement, and therefore, hard materials having pointed shapes, such as crushed stones, are suited. Preferably, a fine aggregate having a particle diameter of 0.5 mm or less is mixed at a ratio of 5% by volume relative to a coarse aggregate having a particle diameter of 0.5 to 30 mm. The coarse aggregate is used for forming a porous structure primarily in order to have water permeability, and hard materials having pointed shapes, such as crushed stones, are suited for forming cavities by mutual engagement. On the other hand, the fine aggregate adheres onto the surface of the large, coarse aggregate and performs a slip-resistance function (an abrasion effect of sand paper, for example) with respect to tires and the like.

The present invention will be described below with reference to examples.

1. Material

The following materials were used for preparing pavement materials in Examples and Comparative examples.

(1) Waste vulcanized rubber: grade name 2050, manufactured by MURAOKA RUBBER RECLAIMING CO., LTD., (particle diameter 2 mm to 5 mm, prepared from spent TBR tires)

(2) Binder: two-component-curing urethane binder

(3) Aggregate: those having particle diameters of 4 mm or less

2. Preparation of Pavement

The above-mentioned materials were mixed in order to achieve a coefficient of restitution shown in the following Table 1, and the resulting mixture was laid, followed by leveling, on a road surface as a substrate also shown in Table 1. The urethane binder was cured by standing for about 24 hours, and therefore, an elastic pavement of each of Examples and Comparative examples was prepared.

3. Evaluation of Pavement Performance

Regarding each of the pavements prepared, the level of the noise reduction was measured using a commercially available car. The noise measurement using the commercially available car was performed with respect to a general dense-graded pavement under the same condition, the amount of noise reduction in terms of decibel was determined, and thereby evaluation was performed. Furthermore, a golf ball was dropped from a height of 100 cm above a pavement surface, and the height of bounce was measured in terms of centimeter at n=5. The average thereof was determined, and therefore, the measurement of the coefficient of restitution to a golf ball of each pavement was performed. These results are collectively shown in the following Table 1 while the dense-graded pavement in Comparative example 1 is assumed to be a control. Regarding the significant difference in the noise reduction, a pavement exhibiting sufficient effect compared with the dense-graded pavement was indicated by ◯, a pavement exhibiting insufficient effect was indicated by Δ, and the dense-graded pavement itself was indicated by x.

TABLE 1

| | Comparative | Comparative | Example | Example | Example | Example |
|---|---|---|---|---|---|---|
| | example 1 | example 2 | 1 | 2 | 3 | 4 |
| Substrate of | Concrete | Concrete | Concrete | Concrete | Concrete | Drainage |
| pavement | | | | | | |
| Thickness of | 40 | 40 | 40 | 40 | 40 | 15 |
| surface pavement | | | | | | |
| (mm) | | | | | | |
| Amount of noise | 0 | 3 | 9 | 11 | 13 | 10 |
| reduction of | | | | | | |
| commercially | | | | | | |
| available car | | | | | | |
| (dB) | | | | | | |
| Significant | | | | | | |
| difference in | X | Δ | ◯ | ◯ | ◯ | ◯ |
| noise reduction | | | | | | |
| Coefficient of | 76 | 73 | 45 | 38 | 35 | 41 |
| restitution to a | | | | | | |
| golf ball | | | | | | |

It was verified from the results shown in the above-mentioned Table 1 that there was a strong correlation between the amount of noise reduction and the coefficient of restitution to a golf ball. Even when the elastic pavement was applied as a topcoat on the drainage pavement, a large effect of reducing noise was able to be achieved by adjusting the coefficient of restitution to a golf ball to fall within a predetermined range.

Industrial Applicability

As described above, according to the waste-rubber-containing elastic pavement material of the present invention, unprecedentedly excellent reduction in the noise can be achieved, and reduction in the cost can also be achieved by the use of recycled waste rubber.

1. A waste-rubber-containing elastic pavement material comprising waste rubber, a binder and an aggregate, wherein a pavement after application has a coefficient of restitution to a golf ball of 20 to 60.

2. The waste-rubber-containing elastic pavement material according to claim 1, wherein the binder is an urethane-based or epoxy-based curable resin.

3. The waste-rubber-containing elastic pavement material according to claim 1, wherein the content of the waste rubber is 30% to 70% by volume.

4. The waste-rubber-containing elastic pavement material according to claim 1, wherein the content of the binder is 10% to 30% by volume.

5. The waste-rubber-containing elastic pavement material according to claim 1, wherein the elastic pavement material is applied as a topcoat of 5 to 30 mm thickness onto a pavement.

6. The waste-rubber-containing elastic pavement material according to claim 5, wherein the pavement is a drainage pavement.
